(19) United States
(12) Patent Application Publication
(10) Pub. No.: US 2020/0304546 A1
(43) Pub. Date: Sep. 24, 2020

(54) MOBILITY CALLER AUTHENTICITY SERVICE SYSTEM AND METHOD

(71) Applicant: Avaya Inc., Santa Clara, CA (US)

(72) Inventor: David Chavez, Broomfield, CO (US)

(21) Appl. No.: 16/362,013

(22) Filed: Mar. 22, 2019

(51) Int. Cl. H04L 29/06; H04M 3/42

(52) U.S. Cl. CPC H04L 65/1076; H04L 63/0853; H04L 69/22; H04M 3/42059

(57) ABSTRACT

Embodiments of the disclosure provide a communication system and method. In one example, the method includes receiving an incoming call message that is being transmitted by a caller's communication device to a callee's communication device, analyzing a caller identification (ID) field of the incoming call message to determine a caller ID associated with the incoming call message, comparing the caller ID with a set of known caller IDs, determining that the caller ID does not match any known caller ID from the set of known caller IDs, and blocking the incoming call message from being transferred to the callee's communication device in response to determining that the caller ID does not match any known caller ID from the set of known caller IDs.

### FIELD OF THE DISCLOSURE

Embodiments of the present disclosure relate generally to communication methods and confirming caller information.

### BACKGROUND

Scammers faking caller identifications (IDs) today is a huge problem, especially when the scammers are spoofing numbers from mobile callers. To combat the problem, new standards are in progress to provide caller identification (ID) verification. There are three standards to verify and authenticate caller ID for calls carried over an Internet Protocol (IP) network.

The three standards are SHAKEN (Signature-based Handling of Asserted information using toKENs), STIR (Secure Telephony Identity Revisited), and Personal Assertion Token/PASSporT (defines a token that can be carried by signaling protocols to cryptographically verify the identity of callers). PASSporT uses the JSON Web Token (JWT) and JSON Web Signature (JWS) formats and defines a standard set of base claims and signature.

RFC 4474bis defines how PASSporT is used in a SIP message defining the identity header. SHAKEN and the “shaken” PASSporT extension define the ability for a service provider originator to sign the call using claims that represent an attestation (“attest”) and unique originating identifier (“origid”).

### BRIEF SUMMARY

Embodiments of the present disclosure are designed to solve the problem of scammers faking caller identification and convincing the callees to do any of a number of harmful things, including giving money or goods based on threats (e.g., tax returns have been rejected, a warrant will be issued for your arrest, etc.). The native mobile application disclosed herein can either verify or block incoming mobile calls based on standards, P-Asserted-Identity header from the origination network, and other caller ID queries, lookups, and verification methods.

In some embodiments, a consumer-oriented application is provided that sits on top of a mobile core with calling capability in the mobile core. If a mobile call with a verified caller ID (e.g., known number, the call uses pending standards STIR/SHAKEN/PASSporT, lookups, queries, or P-Asserted-Identity header from the origination network) comes into a mobile user, the mobile call is allowed through the mobile core based on the caller ID.

If the caller ID cannot be verified (e.g., not a mobile number or cannot be verified with the three standards and other methods described above), the call can be blocked at the mobile core (e.g., between the caller and callee and before the call notification message is provided to the callee's mobile communication device). Alternatively or additionally, a message can be sent to the callee's mobile communication device that an unverified caller attempted to call. The caller may be provided withs a message (e.g., a voice prompt) that their caller ID cannot be verified and that the callee has been notified of the unverified caller ID call attempt. In some embodiments, the call is not held (e.g., dropped) and no message is presented to the callee to accept the call.

One aspect of the present disclosure provides a communication server that includes:

a communications interface;

a processor coupled to the communications interface; and

a computer readable medium coupled with the processor, the computer readable medium comprising processor-executable instructions that include:
instructions that receive an incoming call message that is being transmitted from a caller's communication device to a callee's communication device;
instruction that analyze a caller identification (ID) field of the incoming call message to determine a caller ID associated with the incoming call message;
instructions that compare the caller ID with a set of known caller IDs;
instructions that block the incoming call message from being transferred to the callee's communication device in response to determining that the caller ID does not match any caller ID in the set of known caller IDs.

Another aspect of the present disclosure provides a non-transitory computer readable medium comprising instructions stored therein which, when executed by a processor, the instructions including:

instructions that receive an incoming call message that is being transmitted by a caller's communication device;

instruction that analyze a caller identification (ID) field of the incoming call message to determine a caller ID associated with the incoming call message;

instructions that reference a database of valid caller IDs;

instructions that compare the caller ID with at least some of the valid caller IDs;

instructions that block the incoming call message at a network level in response to determining that the caller ID does not match any caller ID in the at least some valid caller IDs.

Another aspect of the present disclosure provides a method that includes:

receiving, at a processor of a mobile communication server, an incoming call message that is being transmitted by a caller's communication device to a callee's communication device;

analyzing, at the processor, a caller identification (ID) field of the incoming call message to determine a caller ID associated with the incoming call message;

comparing the caller ID with a set of known caller IDs;

determining that the caller ID does not match any known caller ID from the set of known caller IDs; and

blocking the incoming call message from being transferred to the callee's communication device in response to determining that the caller ID does not match any known caller ID from the set of known caller IDs.

### BRIEF DESCRIPTION OF THE DRAWINGS

FIG. 1 is a block diagram depicting a communication system in accordance with at least some embodiments of the present disclosure;

FIG. 2 is a block diagram depicting details of a mobile communication server in accordance with at least some embodiments of the present disclosure;

FIG. 3 is a block diagram depicting a data structure in accordance with at least some embodiments of the present disclosure;

FIG. 4 is a flow diagram depicting a first communication method in accordance with at least some embodiments of the present disclosure; and

FIG. 5 is a flow diagram depicting a second communication method in accordance with at least some embodiments of the present disclosure;

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments of the disclosure provide systems and methods authenticating and appropriately handling calls initiated from a calling party to a called party, either from a mobile network core or directly from an application operating on a communication device being carried by a called party associated with a call. While the flowcharts will be discussed and illustrated in relation to a particular sequence of events, it should be appreciated that changes, additions, and omissions to this sequence can occur without materially affecting the operation of the disclosed embodiments, configuration, and aspects.

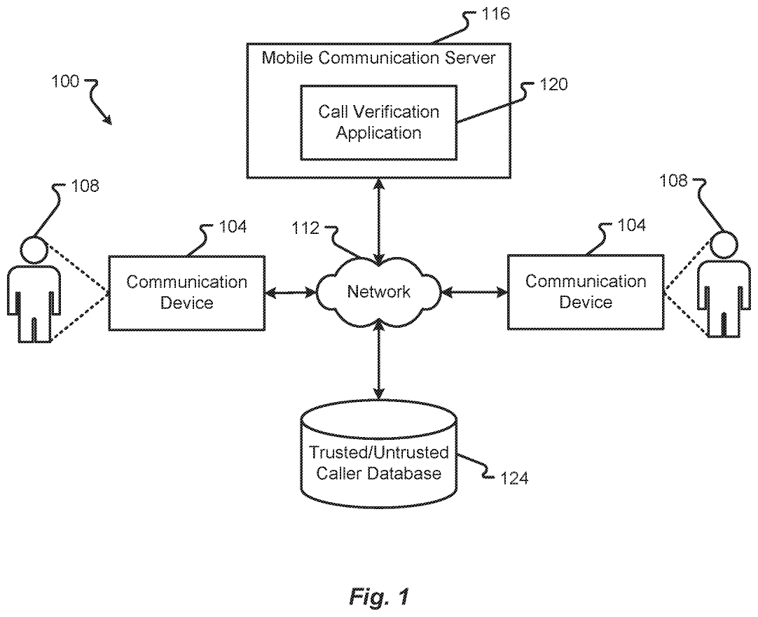

With reference now to FIG. 1, an illustrative communication system 100 will be described in accordance with at least some embodiments of the present disclosure. As shown in FIG. 1, the system 100 may include a number of communication devices 104 in communication with one another via a communication network 112. In one non-limiting embodiment, the communication devices 104 may correspond to mobile communication devices (e.g., smartphones, tablets, wearable devices, etc.) that are carried by users 108. As a non-limiting example, the communication devices 104 may be in communication with one another through one or more mobile networks that may be operated by one or more mobile network operators (MNOs). Accordingly, the network 112 may include a cellular or other wireless network and the communication devices 104 can include smartphones, tablets, laptop computers, wearable devices, or any other portable electronic device configured to communicate over the network 112. It should be understood that while only two communication devices 104 are illustrated here for the sake of simplicity, any number of devices of different types may be connected with the network 112 at any given time. Furthermore, the communication devices 104 may be carried by RCS users that belong to a common MNO, by RCS users that belong to different MNOs, and/or by one or more non-RCS users.

The network 112 can also include an Internet Protocol (IP) Multimedia Subsystem (IMS) framework providing Internet and/or other data services to the communication devices 104 over the network 112. Generally speaking, the network 112 can utilize Session Initiation Protocol (SIP) and/or leverage other Internet Engineering Task Force (IETF) standard protocols to provide any number of IP multimedia services including but not limited to Voice over IP (VoIP) calling, video, media streaming, web access, RCS functions, file transfer functions, etc. Alternatively or additionally, the network 112 may include a distributed computing network such as the Internet or some other packet-based communication network.

The communication system 100 may further include one or more mobile communication servers 116 and a trusted/untrusted caller database 124. In some embodiments, the mobile communication server 116 may be owned and operated by one or multiple MNOs.

The mobile communication server 116 may include, in some embodiments, a call verification application 120 that operates as part of the mobile communication server 116. As will be discussed in further detail herein, the call verification application 120 may correspond to a set of instructions that are executed by a processor of the mobile communication server 116. When executed, the call verification application 120 may enable the mobile communication server 116 to check a call setup message being transferred from one communication device 104 to another communication device 104 before the call setup message reaches the destination communication device 104 (e.g., a callee's communication device 104). In some embodiments, the call verification application 120 may be configured to reference data stored in the trusted/untrusted caller database 124 to discern or determine whether a caller's communication device 104 is trusted, verified, or otherwise a known caller. As used herein, a trusted, known, or verified caller may correspond to a calling user 108 that is calling from a communication device 104 that has been previously known or registered with a callee's communication device 104. The trusted, known, or verified caller may alternatively or additional correspond to a calling user 108 that is calling from a communication device 104 that is known or trusted by the mobile communication server 116. In some embodiments, the data stored in the trusted/untrusted caller database 124 may be available to the mobile communication server 116 to enable the call verification application 120 to intercept and block various untrusted, unknown, or unverified caller's call setup messages from being transferred to a callee's communication device 104. Thus, the concept of a trusted, known, or verified caller may be from the perspective of the MNO, the callee, or a combination thereof. The information stored in the database 124 may be used to identify trusted, known, or verified caller's communication devices 104 (e.g., as a whitelist approach). Alternatively or additionally, information stored in the database 124 may be used to identify untrusted, known, or unverified caller's communication devices 104 (e.g., as a blacklist approach).

Communication information of a trusted or verified or known caller's communication device 104 (e.g., caller ID, calling number, IP address, SIP address, etc.) may be stored in the trusted/untrusted caller database 124. Alternatively or additionally, some of the information that can be stored in the database 124 may be stored in local memory of the mobile communication server 116. Alternatively or additionally, some of the information that can be stored in the database 124 may be stored in memory of a communication device 104, although it may be preferable to store such information within the mobile network core to avoid having a call setup message being transferred all the way across the network 112 to the callee's communication device 104 because such action will consume additional network 112 resources and possibly disrupt/alert on the callee's communication device 104. By intercepting and blocking the call setup message at the mobile network core, network 112 resources are preserved and the callee is not unnecessarily and frustratingly interrupted with a call notification from an untrusted, unknown, or unverified caller's communication device 104.

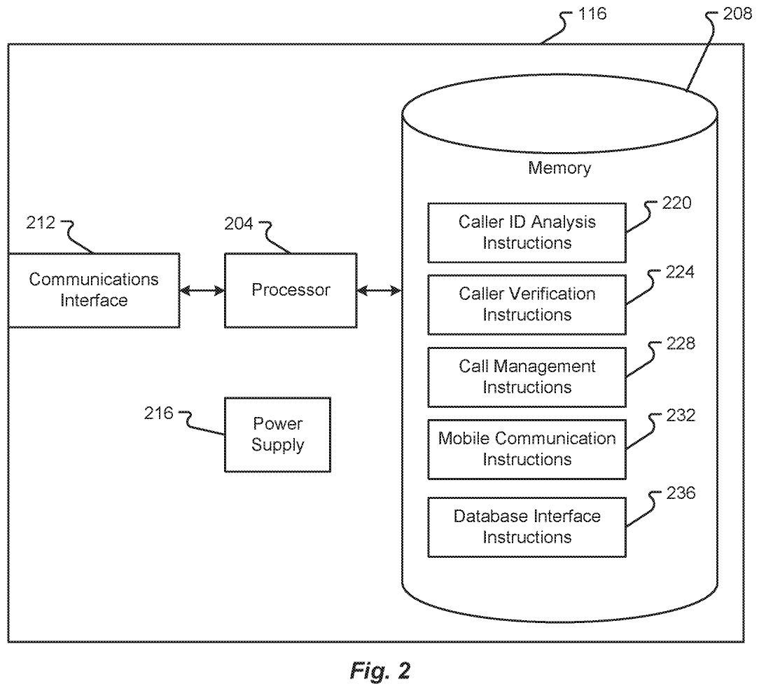

With reference now to FIG. 2, additional details of a mobile communication server 116 will be described in accordance with at least some embodiments of the present disclosure. The mobile communication server 116 is shown to include a processor 204, memory 208, a communication interface 212, and a power supply 216. In some embodiments, all of the components of mobile communication server 116 are provided within a common device housing and are connected via a one or multiple circuit boards.

The processor 204 may correspond to one or multiple processing circuits. In some embodiments, the processor 204 may include a microprocessor, an Integrated Circuit (IC) chip, an ASIC, or the like. The processor 204 may be configured with a plurality of logic circuits or circuit elements that enable the processor 204 to execute one or more instructions or instruction sets maintained in memory 208. Alternatively or additionally, the processor 204 may be configured to execute instructions for operating the communications interface 212. As an example, the processor 204 may be configured to execute one or more drivers that are specifically provided for the communications interface 212.

The memory 208 is shown to be in communication with the processor 204. The memory 208 may include any type or combination of computer memory devices. Non-limiting examples of memory 208 include flash memory, volatile memory, non-volatile memory, RAM, NVRAM, SRAM, ROM, EEPROM, etc. As can be appreciated, the types of devices used for memory 208 may depend upon the nature and type of data stored in memory 208.

In the depicted embodiment, the memory 208 includes one or a plurality of finite/closed-ended instruction sets that are executable by the processor 204. Non-limiting examples of instruction sets that may be provided in memory 208 include a caller ID analysis instruction set 220, a caller verification instruction set 224, a call management instruction set 228, a mobile communication instruction set 232, and a database interface instruction set 236.

The caller ID analysis instruction set 220, when executed by the processor 204, may enable the mobile communication server 116 to extract caller ID information from a call setup message transmitted by a caller's communication device 104. The caller verification instruction set 224, when executed by the processor 204, may enable the mobile communication server 116 to extract other information (e.g., information other than caller ID information) from a call setup message transmitted by a caller's communication device 104. In some embodiments, the caller ID analysis instruction set 220 and call verification instruction set 224 operate in concert with the call management instruction set 228 to intercept a call setup message as it is travelling across a communication network 112 (e.g., through a mobile network core). It should be appreciated that in mobile communications, a call setup message is first transmitted from a communication device 104 to a base station (or wireless access point) and then handled next by a mobile switching center (which may also be referred to as a mobile network core). The mobile communication server 116 may reside in the mobile network core and operate as part of the mobile switching center. When the call setup message is received at the communication interface 212 of the mobile communication server 116, the mobile communication server 116 invokes the call verification application 120 (which may include the caller ID analysis instruction set 220, the caller verification instruction set 224, and the call management instruction set 228), which checks various types of information in the call setup message to determine if the call setup message is allowed to be transferred to the callee's communication device 104. If so, the mobile switching center then routes the call in the same way that a telephone exchange does in a fixed network. It should be appreciated that the mobile communication server 116 may be operating in the mobile network core of the caller's mobile network, of the callee's mobile network, or a combination of the two. In some embodiments, the mobile communication server 116 that executes the call verification application 120 may operate in the mobile network core of the callee's mobile network and may reference a trusted/untrusted caller database 124 that is also maintained in the callee's mobile network core.

The call management instruction set 228 may allow or disallow the call setup message from being further transmitted to the destination identified in the call setup message depending upon the analysis results of the caller ID analysis instruction set 220 and/or caller verification instruction set 224. In some embodiments, the call management instruction set 228 may be configured to block and prevent a call setup message from being transmitted to a callee's communication device 104 if the call setup message does not contain a caller ID that is identified as being trusted, known, or verified based on information referenced in the database 124. Alternatively or additionally, the caller verification instruction set 224 may be invoked if the caller ID analysis instruction set 220 does not recognize the caller ID to perform a further in-depth anlysis of information in the call setup message prior to instructing the call management instruction set 228 to block or not block the call setup message.

The mobile communication instruction set 232, when executed by the processor 204, may enable the mobile communication server 116 to perform various functions of a mobile switching center. For instance, the mobile communication instruction set 232 may be configured to perform call routing functions, enhance mobile call functions, and other functions that are known to be provided by a mobile network core.

The database interface instruction set 236, when executed by the processor 204, may enable the mobile communication server 116 to access and obtain information from the trusted/untrusted caller database 124. In some embodiments, the database interface instruction set 236 may enable the mobile communication server 116 to write entries to the database 124, retrieve or read entries written to the database 124, and/or validate entries prior to committing the entries to the database 124. The database interface instruction set 236 may also enable the mobile communication server 116 to store a portion of the database 124 in memory 208.

The communications interface 212 provides hardware and drivers that enable the mobile communication server 116 to connect with the network 112, receive communications from the network 112, and/or provide communications to the network 112 for delivery to another communication device. In some embodiments, the communications interface 212 includes a wired and/or wireless network adapter. Non-limiting examples of a communications interface 212 include an antenna and associated driver (e.g., a WiFi or 802.11N antenna and/or driver), an Ethernet card and/or driver, a serial data port (e.g., a USB port) and/or driver, a Bluetooth or BLE antenna and/or driver, an NFC antenna and/or driver, or any other type of device that facilitates inter-device communications. The communications interface 212 may receive one or more data packets or messages from the communication network 112 and extract data therefrom. The data extracted from the received data packets or messages may be provided to the processor 204 where the data can subsequently be processed using instructions stored in memory 208. In some embodiments, call setup messages are both received and transmitted via the communications interface 212, although it should be appreciated that different ports (e.g., a receive and send port) may be used for receiving and sending a call setup message.

The power supply 216 may correspond to an internal power source and/or adapter for connection with an external power source. In the example of an internal power source, the power supply 216 may correspond to a battery or cell of batteries used to power the various other components of the mobile communication server 116. Alternatively or additionally, the power supply 216 may include a power converter or power conditioner that enables power received from an external source (e.g., a 120V AC power source) to be converted into useable DC power that can be supplied to the various components of the mobile communication server 116.

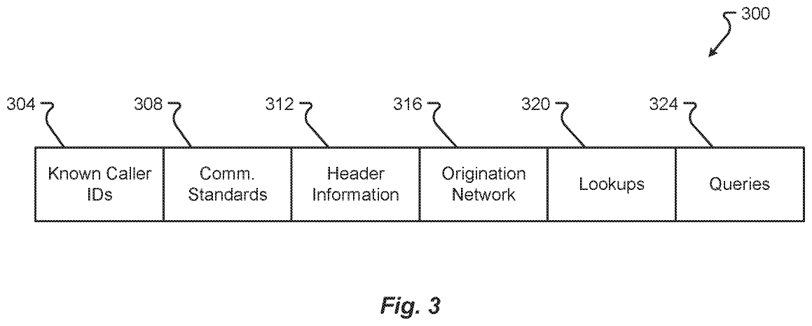

With reference now to FIG. 3, additional details of a data structure 300 that can be used by the call verification application 120 as part of assessing a trust or validity of a call setup message in connection with deciding whether to block the call setup message or not will be described in accordance with at least some embodiments of the present disclosure. The data structure 300 is shown to include a number of data fields, which may be stored in any number of possible computer memory devices. For instance, the fields of the data structure 300 may be stored in memory of a mobile communication server 116, in memory of a communication device 104, in memory of the trusted/untrusted caller database 124, or in combinations thereof. For instance, some of the data fields may be maintained in the database 124 whereas others of the data fields may be maintained in memory of a mobile communication server 116, either persistently or temporarily. It may also be possible that instances of a data field are maintained in both the database 124 and mobile communication server 116.

The illustrative data fields that may be included in the data structure 300 include, without limitation, a known caller ID data field 304, a communication standard data field 308, a header information field 312, an origination network field 316, a lookups field 320, and a queries field 324. In some embodiments, each field may be configured to store some information that can be provided in and extracted from (or discerned from) a call setup message being transmitted from a caller's communication device 104 to a callee's communication device 104. As the name suggests, the known caller ID field 304 may be used to store caller ID information for known, trusted, or verified caller IDs. The known caller ID field 304 may alternatively or additionally include untrusted caller IDs, variants of untrusted caller IDs, or algorithms for identifying an untrusted caller ID (e.g., an identification of a prefix or subset of digits known to be used by an untrusted caller ID as part of a complete caller ID). In some embodiments, the caller ID analysis instruction set 320 may be configured to extract caller ID information from an incoming call setup message and compare the extracted caller ID to one, some, or all of the caller IDs stored in the caller ID field 304. In some embodiments, the caller ID analysis instruction set 320 may be configured to analyze a caller ID of an incoming call setup message using an algorithm or portion of caller ID number contained in the caller ID field 304. Although labeled as a known caller ID field 304, it should be appreciated that the field 304 may alternatively or additionally store data for known, but untrusted caller IDs (e.g., as a blacklist).

The communication standard field 308 may be used to store known, trusted, or verified communication standards that are used or defined within a call setup message. Alternatively or additionally, the communication standard field 308 may store untrusted communication standards which, if the call setup message contains or defines such standards, will result in a blocking of the call setup message and from cancellation of further transmission of the call setup message.

Similarly, the header information field 312 may be used to store known, trusted, or verified header information that can be used or defined within a call setup message. Alternatively or additionally, the header information field 312 may store untrusted header information which, if contained in a call setup message, will cause the call setup message to be blocked.

The origination network field 316 may be used to store known, trusted, or verified origination network information that can be used or defined within a call setup message. Alternatively or additionally, the origination network field 316 may store untrusted origination network information which, if contained in the call setup message, will cause the call setup message to be blocked.

The lookups field 320 may be used to store known, trusted, or verified caller ID lookup information that can be used or defined within a call setup message. Alternatively or additionally, the lookups field 320 may store untrusted caller ID lookup information which, if contained in the call setup message, will cause the call setup message to be blocked.

The queries field 324 may be used to store known, trusted, or verified caller ID queries that are defined within a call setup message. Alternatively or additionally, the queries field 324 may store untrusted caller ID queries which, if contained in the call setup message, will cause the call setup message to be blocked.

In some embodiments, the caller verification instruction set 224 may be configured to compare information extracted from a call setup message information from some or all of the fields 308, 312, 316, 320, 324. The analysis performed by the caller verification instruction set 224 may be performed after, in parallel, in addition, or in lieu of the analysis performed by the caller ID analysis instruction set 220. In some embodiments, the call verification application 120 invokes the instruction sets 220, 224, 228 to verify or block incoming call setup message based on a standard such as SHAKEN, STIR, and/or PASSporT by analyzing P-Asserted-Identity (PAI) header information from the origination network (e.g., against information stored in the header information field 312 and/or orgination network field 316), caller ID lookups defined in the lookups field 320, and/or caller ID queries defined in the queries field 324. In some embodiments, if a call setup message is received with a verified caller ID (e.g., known caller ID number from the field 304) using a SHAKEN, STIR, and/or PASSporT, lookups, queries, or PAI header information from the origination network, then the mobile communication server 116 will allow the call setup message to be transferred to the callee's communication device 104.

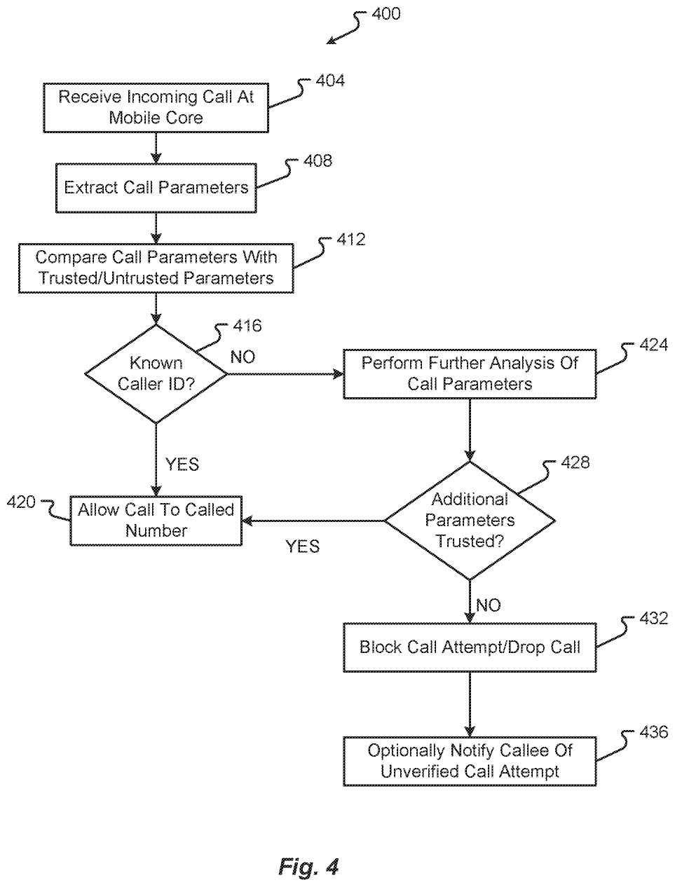

With reference now to FIG. 4, additional details of a first communication method 400 will be described in accordance with at least some embodiments of the present disclosure. The method 400 begins when an incoming call setup message is received at the mobile core (step 404). This step may specifically correspond to the mobile communication server 116 receiving the call setup message at the communication interface 212.

The call setup message may then be passed to the processor 204, which executes the call verification application 120 to extract call parameters from the call setup message (step 408). The parameters extracted from the call setup message may include, without limitation, caller ID information, communication standard information, header information, origination network information, and other information known to be included or defined by a call setup message.

The call verification application 120 then invokes the appropriate instruction sets (e.g., caller ID analysis instruction set 220 and/or caller verification instruction set 224) to compare the extracted call parameters with trusted and/or untrusted call parameters (step 412). In some embodiments, the trusted/untrusted call parameters may be retrieved from the database 124. In some embodiments, the trusted/untrusted call parameters may be retrieved from local memory 208.

The method 400 then continues with the call verification application 120 determining whether the call setup message contained a known, trusted, or verified caller ID (step 416). This query may be answered by the analysis performed by the caller ID analysis instruction set 220. If the query is answered affirmatively, then the call verification application 120 may identify the call setup message as originating from a known, trusted, or verified caller or caller's communication device 104 and, in response thereto, allow the call setup message to be transferred to the callee's communication device 104 (step 420).

On the other hand, if the query of step 416 is answered negatively, then the method may continue with the call verification application 120 performing a further analysis of information contained in the call setup message. Specifically, the call verification application 120 may perform a further analysis of communication standards defined by the call setup message, header information extracted by the call setup message, an origination network associated with the call setup message, or perform other caller ID lookups or queries against the database 124 or other databases in other mobile networks (step 424). The call verification application 120 may then determine if any of the additional parameters allow the call setup message to be treated as originating from a trusted, known, or verified caller or caller's communication device 104 (step 428).

If the query of step 428 is answered affirmatively, then the method 400 may continue to step 420. However, if the query of step 428 is answered negatively, then the method 400 may continue with the call verification application 120 invoking the call management instruction set 228 to block the call attempt and/or drop the call setup message (step 432). In some embodiments, this step may involve the call setup message simply being dropped from further processing by the mobile communication server 116 such that no additional processing, network, or memory resources are committed to the call setup message. Alternatively, the method 400 may include an optional further step where the call verification application 120 notifies the callee of the unverified call attempt, but without transferring the call setup message to the callee's communication device 104 (step 436). For instance, the mobile communication server 116 may transmit a text message, email, or push notification to the callee's communication device 104 indicating that an unverified call attempt was received and blocked, but the mobile communication server 116 may not provide any information extracted from the call setup message. Rather, the callee may only be notified of the event and a time at which the call setup message was received and/or blocked by the mobile communication server 116.

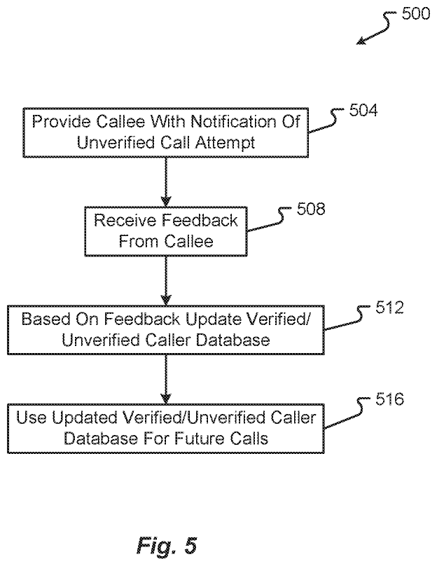

With reference now to FIG. 5, a second communication method 500 will be described in accordance with at least some embodiments of the present disclosure. The method 500 begins with the mobile communication server 116 providing a callee's communication device 104 with a notification of an unverified call attempt (step 504). In some embodiments, step 504 may be similar or identical to optional step 436. In some embodiments, however, certain, but not all, details of the call setup message may be communicated to the callee's communication device 104 (e.g., the caller ID from the call setup message).

The method 500 then continues with the mobile communication server 116 receiving some feedback from the callee in response to the notification (step 508). The feedback may include positive or negative feedback indicating that the callee knows/trusts or doesn't know/doesn't trust the caller based on the information provided in the notification.

Based on the feedback from the callee, the method 500 may continue with the mobile communication server 116 updating the verified/unverified caller database 124 (step 512). The information updated in step 512 may include any field from the data structure 300 and the database 124 may be further updated with a timestamp indicating when the update occurred and/or the callee that provided the information which resulted in the update. The updated trusted/untrusted caller database 124 may then be used by the mobile communication server 116 (and possibly other servers 116) for analysis or reference in connection with further calls or call setup messages (step 516).

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A communication server, comprising:
a communications interface;
a processor coupled to the communications interface; and
a computer readable medium coupled with the processor, the computer readable medium comprising processor-executable instructions that include:
instructions that receive an incoming call setup message that is being transmitted from a caller's communication device addressed to a callee's communication device;
instruction that analyze a caller identification (ID) field of the incoming call setup message to determine a caller ID associated with the incoming call setup message;
instructions that compare the caller ID with a set of known caller IDs;
instructions that, upon determining that the caller ID does not match any caller ID in the set of known caller IDs, performing a subsequent analysis of the call setup message and determining therefrom if the incoming call is permitted or not permitted;
instructions that, determine the incoming call is permitted upon determining that the caller ID does match any caller ID in the set of known caller IDs and
wherein the call setup message is forwarded to the callee's communication device when permitted; and
wherein the instructions are provided as part of a mobile core positioned between the caller's communication device and the callee's communication device in a mobile communication network.

2. The communication server of claim 1, wherein the instructions further include:
instructions that extract header information from the incoming call setup message; and
instructions that analyze the extracted header information in response to determining that the caller ID does not match any caller ID in the set of known caller IDs.

3. The communication server of claim 1, wherein the instructions further include:
instructions that determine a communication standard used by the incoming call setup message; and
instructions that analyze the communication standard in response to determining that the caller ID does not match any caller ID in the set of known caller IDs.

4. The communication server of claim 3, wherein the communication standard comprises at least one of a signature-based handling of asserted information using tokens standard, a secure telephony identity revisited standard, and a personal assertion token/passport standard that uses a web token and web signature format.

5. The communication server of claim 1, wherein the instructions further include:
instructions that provide a message back to the caller's communication device in response to blocking the incoming call setup message.

6. The communication server of claim 5, wherein the instructions that provide a message back to the caller's communication device are configured to provide a voice prompt to the caller's communication device indicating a reason for blocking the incoming call setup message.

7. The communication server of claim 1, wherein the incoming call setup message comprises a voice call directed to a mobile communication device.

8. (canceled)

9. The communication server of claim 1, wherein the instructions further include:
instructions that notify the callee's communication device that a call was attempted by a caller's communication device with an unverified caller ID.

10. A non-transitory computer readable medium comprising instructions stored therein which, when executed by a processor, the instructions comprising:
instructions that receive an incoming call setup message that is being transmitted by a caller's communication device;
instruction that analyze a caller identification (ID) field of the incoming call setup message to determine a caller ID associated with the incoming call setup message;
instructions that reference a database of valid caller IDs;
instructions that compare the caller ID with at least some of the valid caller IDs;
instructions that, upon determining that the caller ID does not match any caller ID in the set of known caller IDs, performing a subsequent analysis of the call setup message and determining therefrom if the incoming call is permitted or not permitted;
instructions that, determine the incoming call is permitted upon determining that the caller ID does match any caller ID in the set of known caller IDs and
instructions that forward the call setup message to the callee's communication device when permitted; and
wherein the instructions are provided as part of a mobile core positioned between the caller's communication device and the callee's communication device in a mobile communication network.

11. The non-transitory computer readable medium of claim 10, wherein the instructions further include:
instructions that extract header information from the incoming call setup message; and
instructions that analyze the extracted header information in response to determining that the caller ID does not match any caller ID in the at least some valid caller IDs.

12. The non-transitory computer readable medium of claim 10, wherein the instructions further include:
instructions that determine a communication standard used by the incoming call setup message; and
instructions that analyze the communication standard in response to determining that the caller ID does not match any caller ID in the at least some valid caller IDs.

13. The non-transitory computer readable medium of claim 12, wherein the communication standard comprises at least one of a signature-based handling of asserted information using tokens standard, a secure telephony identity revisited standard, and a personal assertion token/passport standard that uses a web token and web signature format.

14. The non-transitory computer readable medium of claim 10, wherein the instructions further include:
instructions that provide a message back to the caller's communication device in response to blocking the incoming call setup message, wherein the instructions that provide a message back to the caller's communication device are configured to provide a voice prompt to the caller's communication device indicating a reason for blocking the incoming call setup message.

15. A method, comprising:
receiving, at a processor of a mobile communication server, an incoming call setup message that is being transmitted by a caller's communication device to a callee's communication device;
analyzing, at the processor, a caller identification (ID) field of the incoming call setup message to determine a caller ID associated with the incoming call setup message;
comparing the caller ID with a set of known caller IDs;
determining that the caller ID does not match any known caller ID from the set of known caller IDs; and
upon determining that the caller ID does not match any caller ID in the set of known caller IDs, perform a subsequent analysis of the call setup message and determining therefrom if the incoming call is permitted or not permitted;
determining the incoming call is permitted upon determining that the caller ID does match any caller ID in the set of known caller IDs; and
forwarding the call setup message to the callee's communication device when permitted; and
wherein at least the steps of receiving and blocking are provided as part of a mobile core positioned between the caller's communication device and the callee's communication device in a mobile communication network.

16. The method of claim 15, further comprising:
extracting, with the processor, header information from the incoming call setup message;
analyzing, with the processor, the extracted header information in response to determining that the caller ID does not match any caller ID in the at least some valid caller IDs; and
based on the analysis of the extracted header information, unblocking the incoming call setup message thereby allowing the incoming call setup message to be transmitted to the callee's communication device.

17. The method of claim 15, further comprising:
determining, with the processor, a communication standard used by the incoming call setup message;
analyzing, with the processor, the communication standard in response to determining that the caller ID does not match any caller ID in the at least some valid caller IDs; and
based on the analysis of the communication standard, unblocking the incoming call setup message thereby allowing the incoming call setup message to be transmitted to the callee's communication device.

18. The method of claim 17, wherein the communication standard comprises at least one of a signature-based handling of asserted information using tokens standard, a secure telephony identity revisited standard, and a personal assertion token/passport standard that uses a web token and web signature format.

19. The method of claim 15, further comprising:
providing, with the processor, a message back to the caller's communication device in response to blocking the incoming call setup message.

20. The method of claim 15, further comprising:
notifying, with the processor, the callee's communication device that a call was attempted by the caller's communication device with an unverified caller ID.
